(19) United States
(12) Patent Application Publication
(10) Pub. No.: US 2010/0185861 A1
(43) Pub. Date: Jul. 22, 2010

(54) ANONYMOUS KEY ISSUING FOR ATTRIBUTE-BASED ENCRYPTION

(75) Inventors: Melissa E. Chase, Seattle, WA (US); Sze Ming Chow, New York, NY (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/355,862

(22) Filed: Jan. 19, 2009

(51) Int. Cl. H04L 9/00

(52) U.S. Cl. 713/171

(57) ABSTRACT

The claimed subject matter provides systems and/or methods that establish a decryption key for use with an attribute authority. The system can include components that identify a pseudonym based a global identifier (GID) associated with a user, initiates communication with the attribute authority, and selects a first random value utilized to determine a first value. The system also includes components that select a second random value, employs the first value and the second random value to generate a second value and a third value, receives the second value and the third value, identifies a third random value, and employs the second value, the third value, the first random value, and the third random value to determine a fourth value which is employed to determine a fifth value. The fifth value is employed to derive the decryption key for use with the attribute authority.

### BACKGROUND

People can be identified by their attributes. One attempt to utilize this observation employed key-policy attribute based encryption for threshold policies such that a sender can encrypt a message specifying an attribute set and a number d so that only a recipient with at least d of the given attributes can decrypt the message. Nevertheless, the deployment implication of such a scheme is not entirely realistic in that it assumes the existence of just a single trusted party for issuing secret keys for decryption. Instead there can be different entities responsible for monitoring different attributes of a person, such as the Department of Motor Vehicles to test whether or not one is capable of driving, schools and universities to attest that one is a student, etc. However, all existing schemes to date require that a user identify himself/herself to each attribute monitoring entity, which can be undesirable from a privacy perspective.

The subject matter as claimed is directed toward resolving or at the very least mitigating, one or all the problems elucidated above.

### SUMMARY

The following presents a simplified summary in order to provide a basic understanding of some aspects of the disclosed subject matter. This summary is not an extensive overview, and it is not intended to identify key/critical elements or to delineate the scope thereof. Its sole purpose is to present some concepts in a simplified form as a prelude to the more detailed description that is presented later.

Multi-authority attribute-based encryption (ABE) allows multiple attribute-authorities to distribute attribute-based key decryptions to users, and allows encryptors to specify the attributes to determine which user should be able to decrypt the ciphertext. In accordance with one aspect of the claimed subject matter, a multi-authority attribute-based encryption (ABE) scheme using the concepts of trusted central authority (CA) and global identifier (GID) can be employed. However, it has been observed under this scheme that the central authority can have the ability to decrypt every ciphertext, which is somehow contradictory to the motivation that no single authority can control all attributes in practice. Moreover it has been further observed, the global identifier (GID) enables central authorities to combine their information to figure out all the attributes that a particular user has requested, which can compromise the privacy of the user. Accordingly, to overcome these issues, the claimed matter as described and claimed herein removes the decryption power of the central authority and prevents linking, making attribute-based encryption (ABE) more usable in practice.

To the accomplishment of the foregoing and related ends, certain illustrative aspects of the disclosed and claimed subject matter are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a machine-implemented system that allows a user to obtain a decryption key from an attribute authority without revealing his/her global identifier (GID) to the attribute authority in accordance with the claimed subject matter.

FIG. 2 provides a more detailed depiction of a user device that allows a user to obtain a decryption key from an attribute authority without revealing his/her global identifier (GID) to the attribute authority in accordance with the claimed subject matter.

FIG. 3 provides a more detailed depiction of an attribute authority that allows a user to obtain a decryption key from an attribute authority without revealing his/her global identifier (GID) to the attribute authority in accordance with the claimed subject matter.

FIG. 4 depicts a user's individual and unique overarching global identifier from which various and sundry pseudonyms 404 for utilization with the claimed subject matter can be derived in accordance with an aspect of the claimed subject matter.

FIG. 5 illustrates a flow diagram of a machine implemented methodology that effectuates and/or facilitates a user obtaining a decryption key from an attribute authority without revealing his/her global identifier (GID) to the attribute authority in accordance with an aspect of the claimed subject matter.

FIG. 6 illustrates a method that effectuates and/or facilitates a user obtaining a decryption key from an attribute authority without revealing his/her global identifier (GID) to the attribute authority in accordance with an aspect of the claimed subject matter.

FIG. 7 depicts a further methodology that effectuates and/or facilitates a user obtaining a decryption key from an attribute authority without revealing his/her global identifier (GID) to the attribute authority in accordance with an aspect of the claimed subject matter.

FIG. 8 illustrates a block diagram of a computer operable to execute the disclosed system in accordance with an aspect of the claimed subject matter.

FIG. 9 illustrates a schematic block diagram of an illustrative computing environment for processing the disclosed architecture in accordance with another aspect.

### DETAILED DESCRIPTION

The subject matter as claimed is now described with reference to the drawings, wherein like reference numerals are used to refer to like elements throughout. In the following description, for purposes of explanation, numerous specific details are set forth in order to provide a thorough understanding thereof. It may be evident, however, that the claimed subject matter can be practiced without these specific details. In other instances, well-known structures and devices are shown in block diagram form in order to facilitate a description thereof.

We often identify people by their attributes. One approach proposed key policy attribute-based encryption for threshold policies where a sender can encrypt a message specifying an attribute set and a number d, so that only a recipient with at least d of the given attributes can decrypt the message. However, the deployment implication of this scheme is not entirely realistic, in that it assumes the existence of a single trusted party issuing secret keys for decryption. In actuality, different entities can be responsible for monitoring different attributes of a person, e.g., Department of Motor Vehicles to test whether one can drive, a university to certify whether one is a student, etc. Thus, another proposed approach provides a multi-authority attribute-based encryption (ABE) scheme which supports many different authorities operating simultaneously, each distributing secret keys for different sets of attributes of the person.

Since each authority is responsible for different attributes, in order to ensure that the system is as efficient as possible, the claimed subject matter does not require that the central authorities communicate with one another when issuing secret keys. Accordingly, a global identifier (GID) which no user can claim another user's global identifier (GID) is necessary to prevent user collusion. Unfortunately, the mere existence of such a global identifier (GID) makes the attributes that a particular user had requested from different authorities easily linkable, which is highly undesirable since the complete profile of the user is leaked.

This situation seems to be unavoidable if all ones attributes are determined by some kind of public identity like a name or Social Security number, which means users need to authenticate themselves to get secret keys for a certain set of attributes. However, there are many attributes which do not belong to this category. The ability to drive is a good example. One should be able to prove the ability to do something in an examination and then receive the corresponding credential, without presenting any identifying information. Alternatively, one might interact with a service via a pseudonym (e.g., a login name) and wish to obtain attributes relating to this interaction without revealing one's full identity.

The claimed subject matter overcomes the privacy problem by designing an interactive algorithm by which a user can obtain a set of decryption keys for his/her secret key without revealing any information about that secret key to the authority. At the same time, the authority is guaranteed that the agreed-upon decryption keys are the only thing that the user learns from the transaction.

Before embarking on an extensive discussion of the claimed subject matter, the following preliminaries, notations, and complexity assumptions should be noted without limitation or loss of generality. For the purposes of exposition let ê be a bilinear map such that ê: G₁×G₂→G_{T}, where [symbol] ₁ and [symbol] ₂ are cyclic multiplicative groups of prime order q; each element of [symbol] ₁, [symbol] ₂, and [symbol] _{T} has unique binary representation; g, h generators of [symbol] ₁ and [symbol] ₂ respectively; ψ: [symbol] ₁→ [symbol] ₂ is a computable isomorphism from [symbol] ₁ and [symbol] ₂, with ψ(h)=g; (Bilinear) ∀x ε [symbol] ₁, y ε [symbol] ₂ and a, b ε [symbol] _{q}, ê(x^{a}, y^{b})=ê(x, y)^{ab}; (on-degenerate:) ê(g, h)≠1. One can say that two groups ( [symbol] ₁, [symbol] ₂) is a bilinear group pair if the group action in [symbol] ₁, [symbol] ₂, the isomorphism ψ and the bilinear mapping ê are all efficiently computable.

Further, for the purposes of exposition let algorithm Bilinear_Setup (1^{λ}) output the parameters (ê(•,•), q, g₁, g₂, [symbol] ₁, [symbol] ₂, [symbol] _{T}) where there is an efficiently computable isomorphism ψ from [symbol] ₁, to [symbol] ₂. The decisional Diffie-Heliman (DDH) problem can be defined as follows: given g, g^{a}, g^{b}, g^{c} ε [symbol] as input, decides if c=ab. The decisional bilinear Diffie-Hellman (DBDH) problem can be defined as follows: given g₁ ε [symbol] ₁, g₂, g₂^{a}, g₂^{b}, g₂^{c} ε [symbol] ₂ and Z ε [symbol] _{T} as input, decides if Z=ê(g₁, g₂)^{abc} or ê(g₁, g₂)^{R} for random R← [symbol] _{q}. Additionally, if the q-decisional Diffie-Hellman Inversion (q-DDHI) in prime order group [symbol] = [symbol] g [symbol] is defined as follows: On input a (q+2)-tuple g, g^{s}, g^{s}^{²}, . . . , g^{s}^{^{q}}, g^{u} ε [symbol] ^{k+2}, decides if u=1/s or otherwise. Furthermore, if one were to let algorithm Bilinear_Setup (1^{λ}) output parameters for a bilinear mapping ê: G₁×G₂→G_{T}. The external Diffie-Hellman (XDH) assumption states that, for all probabilistic polynomial time adversaries [symbol] , the decisional Diffie-Hellman (DDH) problem is hard in [symbol] ₁. This implies that there does not exist an efficiently computable isomorphism ψ′:G₁→G₂.

Additionally, throughout the following description of the claimed subject matter, and in particular in relation to multi-authority attribute-based encryption with central authority, GID is employed to denote the global identity of the user and A to denote a set of attributes in general. Further, [symbol] ᵤ and [symbol] _{C} can be utilized to denote the attribute set of a user and the attribute set specified by a ciphertext respectively. Moreover, it can be assumed that all attributes sets can be partitioned into N disjoint sets, and superscript k can employed to denote the attributes handled by authority k. Accordingly, the definition of an N-authority attribute-based encryption (ABE) scheme can consist of four polynomial time algorithms:
1. via (params, {(apkₖ, askₖ)}_{kε{1, . . . N}}) [symbol] Setup(1^{λ}, N) the randomized key generation algorithm takes a security parameter λ ε [symbol] , the number of authorities N ε [symbol] , outputs the system parameters params, and N public/private key pairs (apkₖ, askₖ) for each attribute authority k ε {1, . . . N}. The threshold values dₖ for each authority are also included in params.
2. via uskₖ[GID, [symbol] ^{k}] [symbol] AKeyGen(askₖ, GID, [symbol] ^{k}) the attribute authority k uses its secret key askₖ to output a decryption key for a user with identity GID corresponding to the attribute set [symbol] .
3. via C [symbol] Enc(params, { [symbol] ^{k}}_{kε{1, . . . N}}, m) a sender encrypts a message m in a ciphertext C for the set of attributes { [symbol] ^{k}} where [symbol] ^{k} comes from the attribute domain of the authority k.
4. via m←DEC({uskₖ[GID, [symbol] ^{k}]}_{kε{1, . . . N}}, C) user GID who possesses a set of attribute decryption keys {uskₖ[GID, [symbol] ^{k}]} from each authority k decrypts C to get back the message m.

Consistency requires that for all λ, N ε [symbol] , all identities GID, all messages m, and all C [symbol] Enc(params, { [symbol] ^{k}}_{kε{1, . . . N}}, m), Pr[DEC(AKeyGen(askₖ, GID, [symbol] ^{k})}_{kε{1, . . . N}}, C)=m]=1 when | [symbol] _{C}ⁱ ∩ [symbol] ᵤⁱ|>dₖ for all authorities k ε {1, . . . N}, where the probability is taken over the choice of Setup (1^{λ}, N), and the coins of all the algorithms in the expressions above.

Security can be defined via the following game modeling selective attribute attack.

Experiment EXP_{N-} [symbol] _{Bε,} [symbol] ^{saa}(λ)
GID set←Ø;
( [symbol] _{C}={ [symbol] _{C}¹, . . . , [symbol] _{C}^{N}}, [symbol] _{corr} ⊂ {1, . . . ,N})← [symbol] , | [symbol] _{corr}|<N−2
(params, {(apkₖ, askₖ)}_{kε{1, . . . N}}) [symbol] Setup (1^{λ}, N)
(m*₀, m*₁, state) [symbol] [symbol] ^{AKeyGen(•,•)} (find, params, {apkₖ}_{kε(1, . . . N)}, {askₖ}_{kε} [symbol] _{_{corr}})
b [symbol] {0, 1}, C* [symbol] Enc(params, [symbol] _{C}, m*_{b})
b′ [symbol] [symbol] ^{AKeyGen(•,•)} (guess, C*, state)
If b≠b′ then return 0 else return 1
   where state is information maintained by [symbol] , the AKeyGen(GID, [symbol] ᵤ={ [symbol] ᵤ^{k}}_{kε{1, . . . N}}) oracle can be defined as:
[symbol] [symbol] ←Ø
if (GID ε GIDset) return ⊥;
GID set←{GID} ∪ GIDset;
if ∀ k, (k ε [symbol] _{corr}) V (| [symbol] ᵤ^{k} ∩ [symbol] _{C}^{k}|≧dₖ) return ⊥;
∀ k, [symbol] [symbol] ← [symbol] [symbol] ∪ {AKeyGen (askₖ, GID, [symbol] ^{k})};
return

[symbol]

[symbol]

As mentioned above, a multi-authority attribute-based encryption (ABE) system as described above would have severe privacy shortcomings. If a user must present his/her identifier to every authority, then it will be trivial for the various authorities to combine their data and assemble a complete picture of all of the user's attributes in all domains. Nevertheless, a user might want to keep certain parts of his/her life private. This might not make much sense in the context of physical attributes like drivers license or school information. However, one could imagine applications where some of the authorities are different online service providers giving attributes related to online activities like blog/wiki contributions, access to an online news site, participation in social networking sites, or purchases at an online store. In this case, it would make sense for the user to be able to maintain different, unlinkable attribute sets with each authority.

Accordingly, if it is assumed that each user has a unique secret key and the user can interact with each authority under different pseudonyms in such a way that it is impossible to link multiple pseudonyms corresponding to the same users. At the same time, these pseudonyms can all be tied to the same key so that the user can prove that he/she has both attribute set A from a first authority and attribute set B from a second authority. Thus if one were to treat the global identifier (GID) as the user's secret key, then the user can form different pseudonyms based at least in part on this global identifier (GID) to use when interacting with different authorities. When the user wishes to obtain decryption keys for certain attributes associated with a particular authority, he/she can perform an interactive protocol with the authority. As a result of this protocol, he/she obtains decryption keys tied to the global identifier (GID) that corresponds to his/her pseudonym. These decryption keys can thus be combined with decryption keys obtained from other authorities using pseudonyms for the same global identifier (GID). However, from the authorities' perspective the users global identifier (GID) is completely hidden or masked. In fact, it is infeasible for two authorities to tell that they are communicating with, or referring to, the same user.

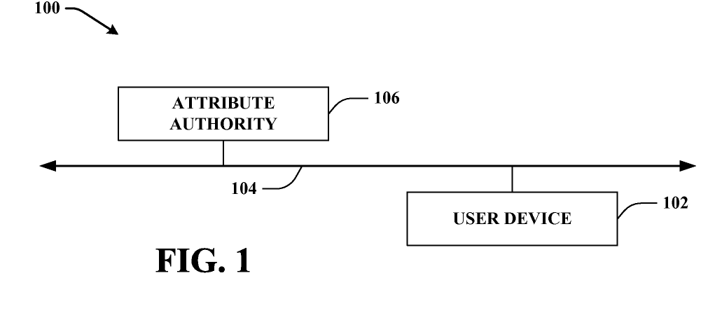

FIG. 1 illustrates a system 100 that allows a user to obtain a decryption key from an attribute authority without revealing his/her global identifier (GID) to the attribute authority. As illustrated, system 100 depicts a user device 102 such as a desktop computer, server class computing device, cell phone, smart phone, laptop computer, notebook computer, Tablet PC, consumer and/or industrial device and/or appliance, hand-held device, personal digital assistant (PDA), multimedia Internet mobile phone, multimedia player, and the like, that a user can typically utilize to communicate with different online service providers that supply credentials or attributes related to online activities such as blog/wiki contributions, access to online news sites, participation in social networking sites, or purchases at an online store. The user can persist his/her unique secret key or global identifier (GID) on user device 102 from which one or more different and/or disparate pseudonyms can be derived. The user, through utilization of user device 102, can thereafter utilize one or more of the different or disparate pseudonyms derived from the persisted unique secret key or global identifier (GID) to interact, through network topology or cloud 104, with attribute authority 106 in such a way that is it impossible for the multiple attribute authorities (e.g., other online news sites, social networking sites, or online stores) to collude to link pseudonyms emanating from, or corresponding to, the same user.

Network topology and/or cloud 104 can include any viable communication and/or broadcast technology, for example, wired and/or wireless modalities and/or technologies can be utilized to effectuate the claimed subject matter. Moreover, network topology and/or cloud 104 can include utilization of Personal Area Networks (PANs), Local Area Networks (LANs), Campus Area Networks (CANs), Metropolitan Area Networks (MANs), extranets, intranets, the Internet, Wide Area Networks (WANs)—both centralized and/or distributed—and/or any combination, permutation, and/or aggregation thereof.

Attribute authority 106, like user device 102, can be but is not limited to, any type of mechanism, machine, device, facility, and/or instrument that includes a processor and/or is capable of effective and/or operative communications with network topology and/or cloud 104. Mechanisms, machines, devices, facilities, and/or instruments that can comprise attribute authority 106 can include Tablet PCs, server class computing machines and/or databases, laptop computers, notebook computers, desktop computers, cell phones, smart phones, consumer appliances and/or instrumentation, industrial devices and/or components, hand-held devices, personal digital assistants, multimedia Internet enabled phones, multimedia players, and the like.

Moreover attribute authority 106 can partake in an interactive protocol with user device 102 in order to provide the user with decryption keys associated with secret key or global identifier (GID) that corresponds with his/her pseudonym. In the interaction between user device 102 and attribute authority 106, user device 102 takes as input a public key of the attribute authority 106, an identity global identifier (GID), a set of attributes, and a corresponding pseudonym together with auxiliary information, and gets in return a decryption key for user with identity global identifier (GID) corresponding to an attribute set. Attribute authority 106 gets a secret key of the attribute authority 106, an attribute set, a certificate, and the pseudonym as input, but gets nothing as output.

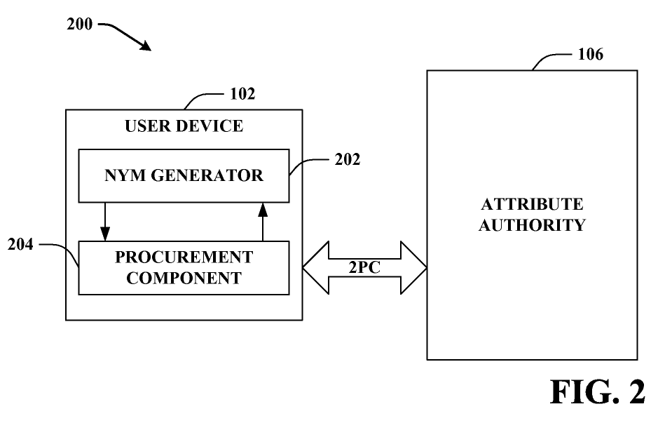

FIG. 2 provides a more detailed depiction 200 of user device 102 in accordance with aspects of the claimed subject matter. As illustrated user device 102 can include nym generator 202 that can probabilistically output a pseudonym for the global identity (GID) (e.g., randomly or probabilistically selected portions or aspects of the overall or overarching global identity (GID)) as well as auxiliary information. The probabilistically generated pseudonym together with the auxiliary information can be conveyed to procurement component 204 that can initiate an interactive protocol with attribute authority 106. As will be appreciated by those reasonably cognizant in this field of endeavor, the pseudonym probabilistically and/or randomly chosen is typically a randomly selected relatively large number.

Procurement component 204, upon receiving the probabilistically and/or randomly selected relatively large number that is the pseudonym, can initiate communications with attribute authority 106 to establish a two party communication (2PC) wherein the pseudonym is conveyed to the attribute authority. Attribute authority 106 can utilize the pseudonym to generate a value (e.g., x). Further attribute authority 106 can also select a random number (e.g., through use of a pseudorandom number generator (not shown)). Attribute authority 106 can then employ the generated value, x, together with the selected random number, to determine two values X₁ and X₂ that can be returned to user device 102, and more particularly procurement component 204. On receipt of the two values X₁ and X₂ from attribute authority 106, procurement component 204 can generate a further random number (e.g., once again through utilization of a pseudorandom number generator). This further random number can be employed by procurement component 204 to establish a second value, Y, which is sent to attribute authority 106. The second value, Y, sent by user device 102, and specifically procurement component 204, can be employed by attribute authority 106 to establish another value, Z that is sent back to user device 102. On receipt of the value Z procurement component 204 can determine a key, D, that the user can thereafter utilize to facilitate secure communications with anyone who encrypts with respect to the attributes monitored by attribute authority 106. It should be noted, without limitation or loss of generality, that the various values (e.g., X₁, X₂, Y, Z, etc.) communicated between procurement component 204 and attribute authority 106 can be subject to a blinding/unblinding functionality, wherein to blind a value, the value is one of multiplied or exponentiated by a random value which typically masks the initial value, and conversely to unblind the value the corresponding inverse operations are performed which unmasks the value.

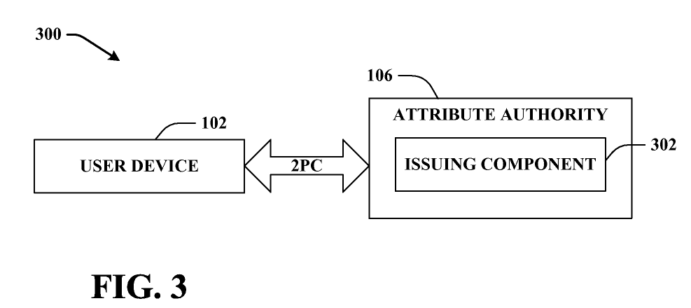

FIG. 3 provides a more detailed depiction 300 of attribute authority 106 in accordance with an aspect of the claimed subject matter. As illustrated attribute authority 106 can include issuing component 302 that can act as a counterpart in the two party communication (2PC) protocol established between user device 102 and itself. Issuing component 302 can accept the pseudonym disseminated from user device 102 to obtain a value (e.g., x), and through use of a pseudorandom number generator (not shown) associated with issuing component 302 can select a random number. Issuing component can thereafter employ the generated value, x, together with the selected random number, to determine two values X₁ and X₂ that can be distributed to user device 102. User device 102 on receipt of the two values X₁ and X₂ from issuing component 302, can obtain a further random number (e.g., through utilization of a pseudorandom number generator). The further random number can subsequently be employed by user device 102 to establish a value, Y, which is returned to issuing component 302. The Y value can be employed by issuing component 302 to establish a value, Z that can be sent back to user device 102. On receipt of the value Z user device 102 can determine a key, D, that a user utilizing user device 102 can subsequently utilize to facilitate and/or effectuate secure communications with attribute authority 106.

To put the foregoing two party computation in more context, the user employing user device 102 can have persisted or associated therewith a key u and attribute authority 106 can have keys α, β, γ that can be utilized jointly by both user device 102 and attribute authority 106 to compute the value (h^{α}g^{1/(β+u)})^{γ} for commonly known g and h (e.g., generators of cyclic multiplicative groups of prime order q). It should be noted that only the user gets this output (e.g., (h^{α}g^{1(β+u)})^{γ}). User device 102 randomly selects pseudonym ρ₁ ε_{R} [symbol] _{q} and form a pseudonym which is then directed to attribute authority 106. Attribute authority 106 can then determine a value x to comply with the equation: x:=(β+u)ρ₁, and can further identify a random number r ε_{R} [symbol] _{q}. Attribute authority 106 can then employ the value x and the random number r to determine two values X₁ and X₂, where X₁:=g^{r/x}, X₂:=h^{ar}. The two values determined by attribute authority 106 can then be directed to user device 102 at which point user device 102 can select another randomly selected number ρ₂ ε_{R} [symbol] _{q} which can be utilized to obtain a value Y from the equation Y:=(X₁^{ρ1}·X₂)^{ρ2} which can be sent back to attribute authority 106. Attribute authority at this juncture can compute Z from the equation Z:=Y^{γ/r}. The value Z can be conveyed to user device 102 where it can be utilized to obtain a value D in the following equation D=Z^{1/ρ2}. The value D can thereafter be employed by a user utilizing user device 102 to facilitate and/or effectuate secure communications with attribute authority 106.

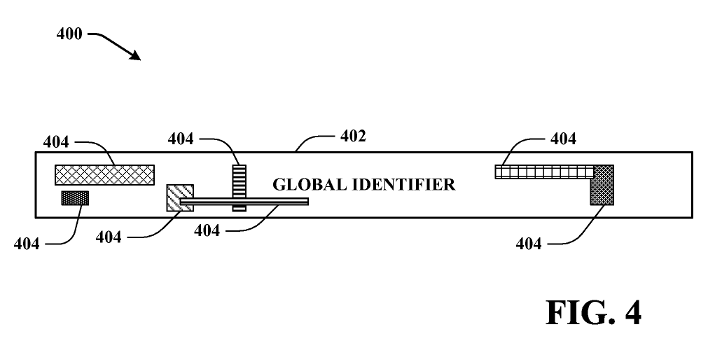

FIG. 4 illustrates the concept 400 of a user's individual and unique overarching global identifier 402 from which various and sundry pseudonyms 404 for utilization with the claimed subject matter can be derived. As will be observed the pseudonyms 404 are generally sub-portions of the global identifier 402. The global identifier 402 for all intents and purposes is secret (e.g., not provided to any attribute authority 106) or for that matter divulged. As will be appreciated the only party that has full knowledge or possession of global identifier 402 is the user, all pseudonyms 404 employed to obtain keys from one or more attribute authorities are derived from the overarching global identifier 402. As will be further observed pseudonyms 404 can include distinct aspects of global identifier 402 or can include overlapping attributes of global identifier 402, wherein each pseudonym 404 is typically determined as a function of the global identifier 402 and includes some additional randomness.

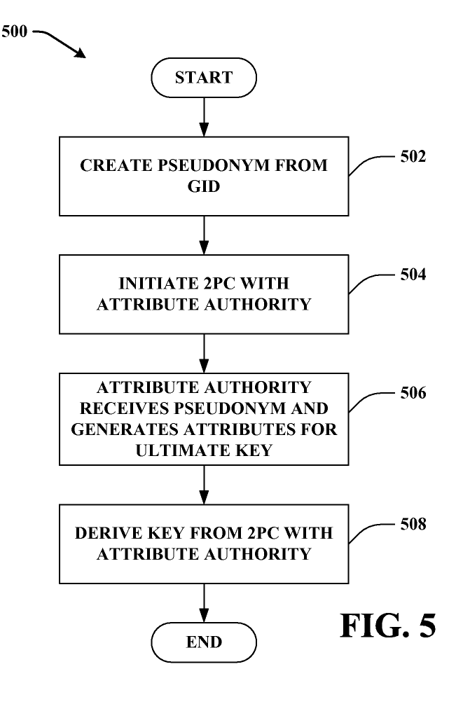

In view of the illustrative systems shown and described supra, methodologies that may be implemented in accordance with the disclosed subject matter will be better appreciated with reference to the flow chart of FIGS. 5-7. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter. Additionally, it should be further appreciated that the methodologies disclosed hereinafter and throughout this specification are capable of being stored on an article of manufacture to facilitate transporting and transferring such methodologies to computers.

The claimed subject matter can be described in the general context of computer-executable instructions, such as program modules, executed by one or more components. Generally, program modules can include routines, programs, objects, data structures, etc. that perform particular tasks or implement particular abstract data types. Typically the functionality of the program modules may be combined and/or distributed as desired in various aspects.

FIG. 5 provides illustration of a method 500 that effectuates and/or facilitates a user obtaining a decryption key from an attribute authority without revealing his/her global identifier (GID) to the attribute authority. Method 500 can commence at 502 where a pseudonym can be derived from a larger overarching global identifier (GID), the derivation of the pseudonym can be performed on a user device such as desktop computer, laptop computer, smart phone, cell phone, and the like. At 504 a two party computation (2PC) can be initiated with an attribute authority. Such an attribute authority can include online service providers giving attributes related to online activities like blog/wiki contributions, access to online news sites, participation in social networking sites, or purchases at online stores, for instance. At 506 the attribute authority can receive the pseudonym from the user device and can thereafter generate attributes necessary for the key that will ultimately be employed by a user partake in one or more online activities. At 508 from the two party communication (2PC) between the attribute authority and the user device can derive a key that can be utilized by the user to facilitate and/or effectuate secure communications encrypted with the attributes controlled by one or more online service providers.

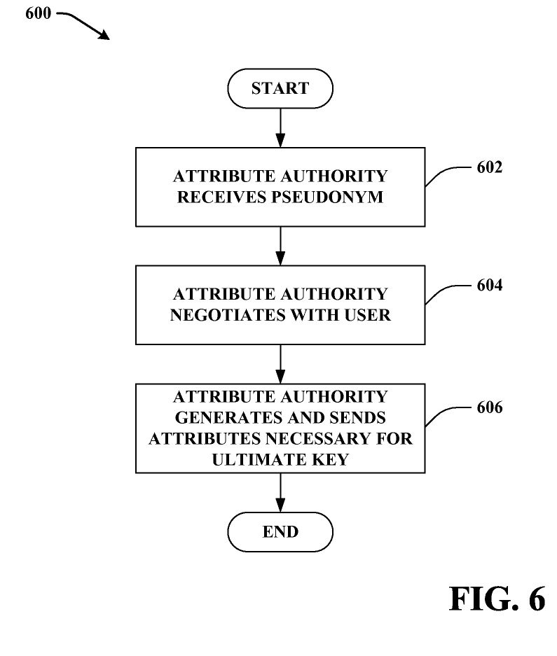

FIG. 6 illustrates a method 600 that effectuates and/or facilitates a user obtaining a decryption key from an attribute authority without revealing his/her global identifier (GID) to the attribute authority in accordance with an aspect of the claimed subject matter. Method 600 can commence at 602 where an attribute authority can have received input from a user device in the form of a pseudonym. Receipt of the pseudonym from the user device can initiate a two party computation (2PC) between the user device and the attribute authority. At 604 a series of communications between the attribute authority and the user device can be carried out. At 606 the attribute authority can generate and send a set of attributes to the user device which the user device can utilize to generate or determine a key that can be used to facilitate and/or effectuate secure communications and/or transactions encrypted with the attributes controlled by one or more online service providers.

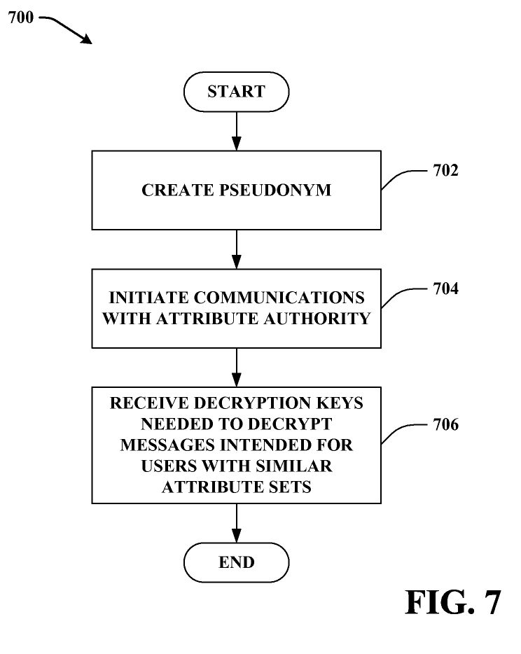

FIG. 7 depicts a method 700 that effectuates and/or facilitates a user obtaining a decryption key from an attribute authority without revealing his/her global identifier (GID) to the attribute authority in accordance with an aspect of the claimed subject matter. Method 700 can start at 702 where a pseudonym can be obtained or extracted from a global identifier persisted on a user device and/or associated with a particular user. At 704 the user device can initiate communication with an attribute authority in order to effectuate a two party computation (2PC) wherein various information is exchanged between the two parties in order to generate a set of decryption keys that correspond to the user's attributes which can then be used by a user of the user device to decrypt messages intended for users with similar attribute sets. At 706 the user device can receive the decryption keys resultant from the two party computation (2PC) and can employ one or more of these decryption keys to decrypt messages intended for users with similar attribute sets.

The claimed subject matter can be implemented via object oriented programming techniques. For example, each component of the system can be an object in a software routine or a component within an object. Object oriented programming shifts the emphasis of software development away from function decomposition and towards the recognition of units of software called “objects” which encapsulate both data and functions. Object Oriented Programming (OOP) objects are software entities comprising data structures and operations on data. Together, these elements enable objects to model virtually any real-world entity in terms of its characteristics, represented by its data elements, and its behavior represented by its data manipulation functions. In this way, objects can model concrete things like people and computers, and they can model abstract concepts like numbers or geometrical concepts.

As used in this application, the terms “component” and “system” are intended to refer to a computer-related entity, either hardware, a combination of hardware and software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Artificial intelligence based systems (e.g., explicitly and/or implicitly trained classifiers) can be employed in connection with performing inference and/or probabilistic determinations and/or statistical-based determinations as in accordance with one or more aspects of the claimed subject matter as described hereinafter. As used herein, the term “inference,” “infer” or variations in form thereof refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, all or portions of the claimed subject matter may be implemented as a system, method, apparatus, or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Some portions of the detailed description have been presented in terms of algorithms and/or symbolic representations of operations on data bits within a computer memory. These algorithmic descriptions and/or representations are the means employed by those cognizant in the art to most effectively convey the substance of their work to others equally skilled. An algorithm is here, generally, conceived to be a self-consistent sequence of acts leading to a desired result. The acts are those requiring physical manipulations of physical quantities. Typically, though not necessarily, these quantities take the form of electrical and/or magnetic signals capable of being stored, transferred, combined, compared, and/or otherwise manipulated.

It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the foregoing discussion, it is appreciated that throughout the disclosed subject matter, discussions utilizing terms such as processing, computing, calculating, determining, and/or displaying, and the like, refer to the action and processes of computer systems, and/or similar consumer and/or industrial electronic devices and/or machines, that manipulate and/or transform data represented as physical (electrical and/or electronic) quantities within the computer's and/or machine's registers and memories into other data similarly represented as physical quantities within the machine and/or computer system memories or registers or other such information storage, transmission and/or display devices.

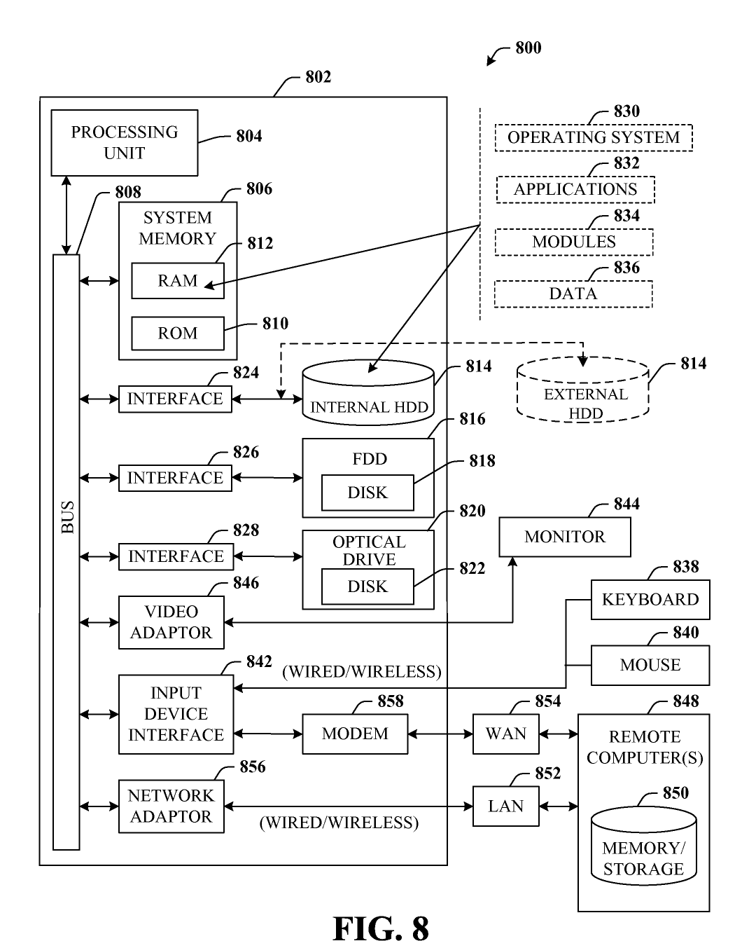

Referring now to FIG. 8, there is illustrated a block diagram of a computer operable to execute the disclosed system. In order to provide additional context for various aspects thereof, FIG. 8 and the following discussion are intended to provide a brief, general description of a suitable computing environment 800 in which the various aspects of the claimed subject matter can be implemented. While the description above is in the general context of computer-executable instructions that may run on one or more computers, those skilled in the art will recognize that the subject matter as claimed also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer readable media. Computer readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 8, the illustrative environment 800 for implementing various aspects includes a computer 802, the computer 802 including a processing unit 804, a system memory 806 and a system bus 808. The system bus 808 couples system components including, but not limited to, the system memory 806 to the processing unit 804. The processing unit 804 can be any of various commercially available processors. Dual microprocessors and other multi-processor architectures may also be employed as the processing unit 804.

The system bus 808 can be any of several types of bus structure that may further interconnect to a memory bus (with or without a memory controller), a peripheral bus, and a local bus using any of a variety of commercially available bus architectures. The system memory 806 includes read-only memory (ROM) 810 and random access memory (RAM) 812. A basic input/output system (BIOS) is stored in a non-volatile memory 810 such as ROM, EPROM, EEPROM, which BIOS contains the basic routines that help to transfer information between elements within the computer 802, such as during start-up. The RAM 812 can also include a high-speed RAM such as static RAM for caching data.

The computer 802 further includes an internal hard disk drive (HDD) 814 (e.g., EIDE, SATA), which internal hard disk drive 814 may also be configured for external use in a suitable chassis (not shown), a magnetic floppy disk drive (FDD) 816, (e.g., to read from or write to a removable diskette 818) and an optical disk drive 820, (e.g., reading a CD-ROM disk 822 or, to read from or write to other high capacity optical media such as the DVD). The hard disk drive 814, magnetic disk drive 816 and optical disk drive 820 can be connected to the system bus 808 by a hard disk drive interface 824, a magnetic disk drive interface 826 and an optical drive interface 828, respectively. The interface 824 for external drive implementations includes at least one or both of Universal Serial Bus (USB) and IEEE 1094 interface technologies. Other external drive connection technologies are within contemplation of the claimed subject matter.

The drives and their associated computer-readable media provide nonvolatile storage of data, data structures, computer-executable instructions, and so forth. For the computer 802, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the illustrative operating environment, and further, that any such media may contain computer-executable instructions for performing the methods of the disclosed and claimed subject matter.

A number of program modules can be stored in the drives and RAM 812, including an operating system 830, one or more application programs 832, other program modules 834 and program data 836. All or portions of the operating system, applications, modules, and/or data can also be cached in the RAM 812. It is to be appreciated that the claimed subject matter can be implemented with various commercially available operating systems or combinations of operating systems.

A user can enter commands and information into the computer 802 through one or more wired/wireless input devices, e.g., a keyboard 838 and a pointing device, such as a mouse 840. Other input devices (not shown) may include a microphone, an IR remote control, a joystick, a game pad, a stylus pen, touch screen, or the like. These and other input devices are often connected to the processing unit 804 through an input device interface 842 that is coupled to the system bus 808, but can be connected by other interfaces, such as a parallel port, an IEEE 1094 serial port, a game port, a USB port, an IR interface, etc.

A monitor 844 or other type of display device is also connected to the system bus 808 via an interface, such as a video adapter 846. In addition to the monitor 844, a computer typically includes other peripheral output devices (not shown), such as speakers, printers, etc.

The computer 802 may operate in a networked environment using logical connections via wired and/or wireless communications to one or more remote computers, such as a remote computer(s) 848. The remote computer(s) 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wired/wireless connectivity to a local area network (LAN) 852 and/or larger networks, e.g., a wide area network (WAN) 854. Such LAN and WAN networking environments are commonplace in offices and companies, and facilitate enterprise-wide computer networks, such as intranets, all of which may connect to a global communications network, e.g., the Internet.

When used in a LAN networking environment, the computer 802 is connected to the local network 852 through a wired and/or wireless communication network interface or adapter 856. The adaptor 856 may facilitate wired or wireless communication to the LAN 852, which may also include a wireless access point disposed thereon for communicating with the wireless adaptor 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wired or wireless device, is connected to the system bus 808 via the serial port interface 842. In a networked environment, program modules depicted relative to the computer 802, or portions thereof, can be stored in the remote memory/storage device 850. It will be appreciated that the network connections shown are illustrative and other means of establishing a communications link between the computers can be used.

The computer 802 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet).

Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11 a is an extension to IEEE 802.11 that applies to wireless LANs and provides up to 54 Mbps in the 5 GHz band. IEEE 802.11a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a fallback to 5.5, 2 and 1 Mbps) in the 2.4 GHz band. IEEE 802.11g applies to wireless LANs and provides 20+ Mbps in the 2.4 GHz band. Products can contain more than one band (e.g., dual band), so the networks can provide real-world performance similar to the basic 10BaseT wired Ethernet networks used in many offices.

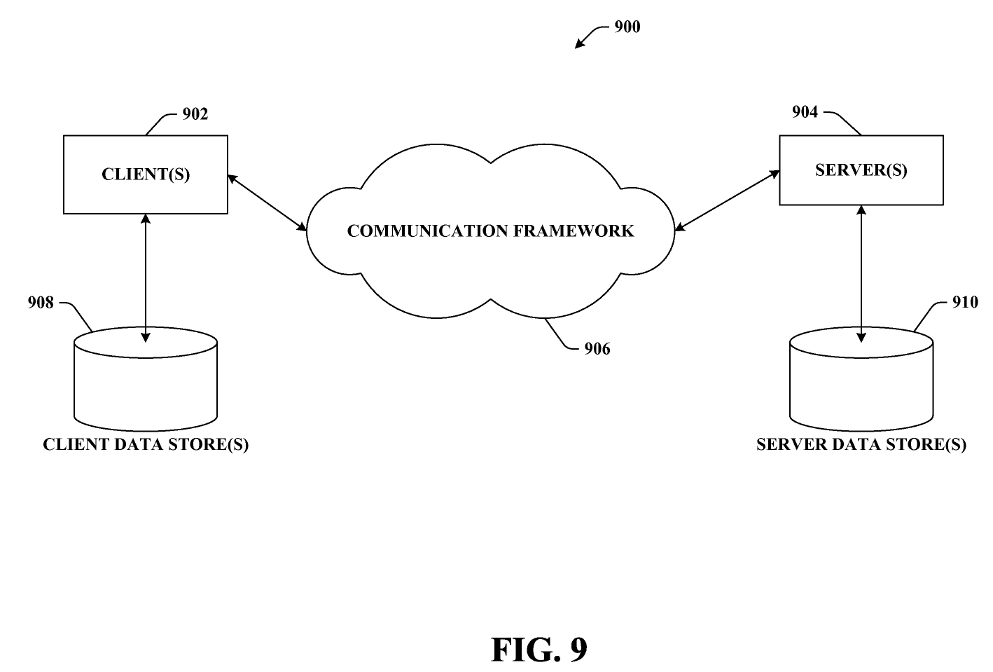

Referring now to FIG. 9, there is illustrated a schematic block diagram of an illustrative computing environment 900 for processing the disclosed architecture in accordance with another aspect. The system 900 includes one or more client(s) 902. The client(s) 902 can be hardware and/or software (e.g., threads, processes, computing devices). The client(s) 902 can house cookie(s) and/or associated contextual information by employing the claimed subject matter, for example.

The system 900 also includes one or more server(s) 904. The server(s) 904 can also be hardware and/or software (e.g., threads, processes, computing devices). The servers 904 can house threads to perform transformations by employing the claimed subject matter, for example. One possible communication between a client 902 and a server 904 can be in the form of a data packet adapted to be transmitted between two or more computer processes. The data packet may include a cookie and/or associated contextual information, for example. The system 900 includes a communication framework 906 (e.g., a global communication network such as the Internet) that can be employed to facilitate communications between the client(s) 902 and the server(s) 904.

Communications can be facilitated via a wired (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

What has been described above includes examples of the disclosed and claimed subject matter. It is, of course, not possible to describe every conceivable combination of components and/or methodologies, but one of ordinary skill in the art may recognize that many further combinations and permutations are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A machine implemented system that effectuates obtaining a decryption key, or part thereof, from an attribute authority without revealing a global identifier (GID) to the attribute authority, comprising:
a processor configured for identifying a pseudonym based at least in part on the global identifier (GID), initiating communication with the attribute authority, selecting a first random value, sending and receiving a series of messages to the attribute authority, receiving values from the attribute authority, selecting a second random value, employing the received values from the attribute authority and the second random value to generate a third value, sending the third value to the attribute authority, receiving a final value from the attribute authority, utilizing the final value and the second random number to determine a fifth value, and utilizing the fifth value to derive the decryption key; and
a memory coupled to the processor for persisting data.

2. The system of claim 1, the initiating communication establishes a two party computation (2PC) where a first set of messages is dispatched executing computation of a blinding function applied to a combination of a user's secret and the attribute authority's secret, using the first random value.

3. The system of claim 1, the third value determined by subjecting the first value to an unblinding function, combining the unblinded first value with the second value, and employing a blinding function on the combined values using the second random value.

4. The system of claim 3, the blinding function utilizes one of multiplication or exponentiation on the combined values and the second random value.

5. The system of claim 3, the unblinding function utilizes one of exponentiation or division on the first value to determine the unblinded first value.

6. The system of claim 1, the fifth value determined by subjecting the final value received from the attribute authority to an unblinding function.

7. The system of claim 1, the global identifier (GID) persisted in the memory.

8. A machine implemented method for establishing a decryption key for use with an attribute authority, comprising:
identifying a pseudonym based at least in part on a global identifier (GID);
initiating communication with the attribute authority;
selecting a first random value;
sending and receiving a series of messages to the attribute authority;
receiving values from the attribute authority;
selecting a second random value;
employing the received values from the attribute authority and the second random value to generate a third value;
sending the third value to the attribute authority;
receiving a final value from the attribute authority;
employing the final value and the second random number to determine a fifth value; and
utilizing the fifth value to derive the decryption key.

9. The method of claim 8, the initiating communication establishes a two party computation where a first set of messages is dispatched executing computation of a blinding function applied to a combination of a user's secret and the attribute authority's secret, using the first random value.

10. The method of claim 8, the third value determined by subjecting the first value to an unblinding function, combining the unblinded first value with the second value, and employing a blinding function on the combined values using the second random value

11. The method of claim 10, the blinding function utilizes one of multiplication or exponentiation on the combined values and the second random value.

12. The method of claim 10, the unblinding function utilizes one of exponentiation or division on the first value to determine the unblinded first value.

13. The method of claim 8, the fifth value determined by subjecting the final value received from the attribute authority to an unblinding function

14. The method of claim 8, the decryption key combinable with one or more other decryption keys obtained from one or more other attribute authorities that employ pseudonyms obtained from the global identifier (GID).

15. A machine implemented system that issues to a user a decryption key or part thereof, comprising:
a memory that retains instructions related to receiving communication from a user, sending and receiving a series of messages to the user, deriving from these messages a first value, selecting a random value, using the first value and the random value and persisted secret values to determine a second value and a third value, sending the second value and the third value to the user, receiving a fourth value, computing a fifth value from the random value and the fourth value, and sending the fifth value to the user; and
a processor, coupled to the memory, configured to execute the instructions retained in the memory.

16. The system of claim 15, the receiving communication from a user establishes a two party computation (2PC) where a first set of messages is dispatched executing computation of a blinding function applied to a combination of a user's secret and the attribute authority's secret, and a random value chosen by the user.

17. The system of claim 15, subjecting the first value to a blinding function that employs the random value to determine the second value.

18. The system of claim 15, subjecting one of the persisted secret values to a blinding function that utilizes the random value to ascertain the third value.

19. The system of claim 15, the fifth value obtained by employing an unblinding function on the fourth value.

20. The system of claim 19, the unblinding function employs one of exponentiation or division to unmask the fourth value.
